(19) United States
(12) Patent Application Publication
(10) Pub. No.: US 2020/0172197 A1
(43) Pub. Date: Jun. 4, 2020

(54) BICYCLE SPROCKET

(71) Applicant: TIEN HSIN INDUSTRIES CO., LTD., Taichung City (TW)

(72) Inventor: TZU-TAI HUANG, Taichung City (TW)

(73) Assignee: TIEN HSIN INDUSTRIES CO., LTD., Taichung City (TW)

(21) Appl. No.: 16/204,402

(22) Filed: Nov. 29, 2018

(51) Int. Cl. B62M 9/10; F16H 55/30

(52) U.S. Cl. CPC B62M 9/105; F16H 55/30

(57) ABSTRACT

A bicycle sprocket comprises a sprocket body, a sprocket ring, a plurality of limiting members, and a plurality of reinforcing members. The sprocket ring has a plurality of ring pieces, each of which includes a plurality of sprocket teeth. Through the movement of the sprocket ring relative to the sprocket body, the axially movable scope of the sprocket ring limited by the limiting members, and the binding strength between the adjacent ring pieces stabilized by the reinforcing members, the sprocket ring can shift relative to the sprocket body in order to reduce the friction and noise generated by the sprocket teeth of the ring pieces and the chain when the bicycle sprocket drives the chain to move.

### BACKGROUND OF THE INVENTION

### Technical Field

The present disclosure is related to a bicycle sprocket, and, more particularly, to a bicycle sprocket that reduces wear of sprocket teeth.

### Description of Related Art

The pedal is the main structure of the bicycle for the rider to drive the bicycle. The pedal is pivotally connected to one end of the crank, and the other end of the crank is coupled to a bicycle chainring 500. A chain 52 engaging the chainring teeth 51 of the bicycle chainring 500, and also engaging with the sprocket teeth 61 of the sprocket 62 of the rear freewheel 600 mounted on the rear wheel, so that the bicycle chainring 500 and the rear freewheel 600 can be driven by the chain 52 to rotate when the rider pedaling the pedal (referring to FIG. 1A). In addition, the rear freewheel 600 includes a plurality of sprockets 62 which are arranged in an order according to different diameters. When the rider changing the speed, the chain 52 will be shifted from one of the sprockets 62 of the rear freewheel 600 to another sprocket 62 with different diameter, so as to vary the gear ratio of the front chainring to the rear freewheel in accordance with the rider's needs.

However, during the chain shifting between different sprockets 62, the chain 52 will generate lateral stress with respect to the bicycle chainring 500 and the rear freewheel 600 because of the inclination angles of the chain 52 (referring to FIG. 1B). The lateral stress causes friction between the rear freewheel 600 and the chain 52 as well as friction between the front chainring 500 and the chain 52. Therefore, the bicycle chainring 500 and the chainring teeth 51 will be worn and noise will be generated, increasing the replacement rate of the bicycle chainring 500 or the rear freewheel 600.

### BRIEF SUMMARY OF THE INVENTION

In view of the above, the purpose of the present disclosure is to provide a bicycle sprocket which can reduce the wear of the sprocket teeth so as to increase the service life of the bicycle sprocket.

The present disclosure provides a bicycle sprocket including a sprocket body, a sprocket ring, and a plurality of limiting members. The sprocket body includes a plurality of first joint portions, each of which is disposed on a radially outer periphery of the sprocket body. The sprocket ring has a plurality of ring pieces, each of which includes a plurality of sprocket teeth and a second joint portion. Each of the sprocket teeth is disposed on a radially outer periphery of the ring piece, and the second joint portion is disposed on a radially inner circumference of the ring piece. Each of the first joint portions of the sprocket body cooperates with the second joint portion of each of the ring piece, and each of the limiting members is disposed on an axial surface of two adjacent ring pieces.

The advantage of the present disclosure is that the sprocket ring composed of the ring pieces can be operated on the sprocket body more smoothly, and can be shifted correspondingly as the chain is shifted, so that the friction between the sprocket teeth of the ring pieces and the chain is reduced to moderate the wear of the sprocket teeth 21, thereby lowering the replacement rate of the bicycle sprocket and prolonging the service life.

### BRIEF DESCRIPTION OF THE SEVERAL VIEWS OF THE DRAWINGS

The present disclosure will be best understood by referring to the following detailed description of some illustrative embodiments in conjunction with the accompanying drawings, in which

FIG. 1A is a schematic view showing the relative position of a conventional bicycle sprocket and a chain before the bicycle performs a shifting operation;

FIG. 1B is a schematic view showing the relative position of a conventional bicycle sprocket and a chain after the bicycle performs a shifting operation;

FIG. 2 is a perspective view of a bicycle sprocket according to a first embodiment of the present disclosure;

FIG. 3 is a perspective view of a sprocket body according to the first embodiment of the present disclosure;

FIG. 4 is a top view of a bicycle sprocket according to the first embodiment of the present disclosure;

FIG. 5 is a schematic view showing the width between the limiting members and the width of the recess of the sprocket body in the axial direction according to the first embodiment of the present disclosure;

FIG. 6 is a partially exploded view of the bicycle sprocket according to the first embodiment of the present disclosure;

FIG. 7 is a perspective view of a reinforcing member according to the first embodiment of the present disclosure;

FIG. 8 is a partially enlarged perspective view of a plurality of ring pieces according to the first embodiment of the present disclosure;

FIG. 9 is a schematic view showing the length relationship between the first joint portion and the recess in the circumferential direction according to the first embodiment of the present disclosure;

FIG. 10 is a schematic view showing the assembling of the first joint portion and the recess according to the first embodiment of the present disclosure;

FIG. 11 is a schematic view showing the combination relationship between the first joint portion and the recess according to the first embodiment of the present disclosure;

FIG. 12 is a plan view showing that the ring pieces form a sprocket ring around the outer periphery of the sprocket body according to the first embodiment of the present disclosure;

FIG. 13 is a perspective view showing the limiting members pressing and abutting the sprocket body according to the first embodiment of the present disclosure;

FIG. 14 is a schematic view showing the movement and offset of the reinforcing members without being affected by the ring pieces according to the first embodiment of the present disclosure;

FIG. 15 is a schematic view showing the movement and offset of the reinforcing members being affected by the ring pieces according to the first embodiment of the present disclosure;

FIG. 16 is a cross-sectional view showing the corresponding relationship between the first side wall and the second side wall according to the first embodiment of the present disclosure;

FIG. 17 is a cross-sectional view showing the corresponding relationship between the first side wall and the second side wall according to the second embodiment of the present disclosure;

FIG. 18 is a cross-sectional view showing the corresponding relationship between the first side wall and the second side wall according to the third embodiment of the present disclosure; and

FIG. 19 is a cross-sectional view showing the corresponding relationship between the first side wall and the second side wall according to the fourth embodiment of the present disclosure.

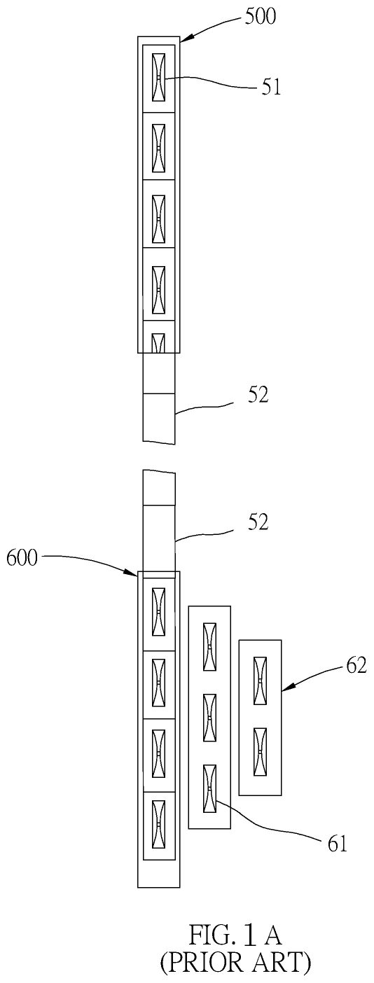

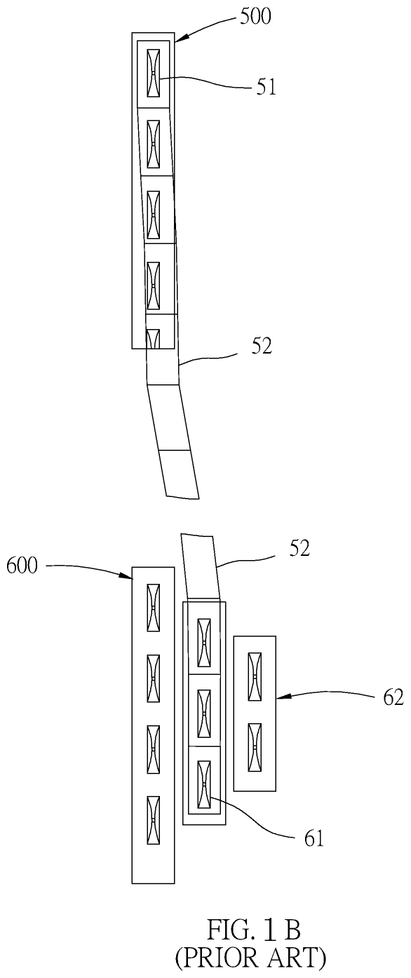

### DETAILED DESCRIPTION OF THE INVENTION

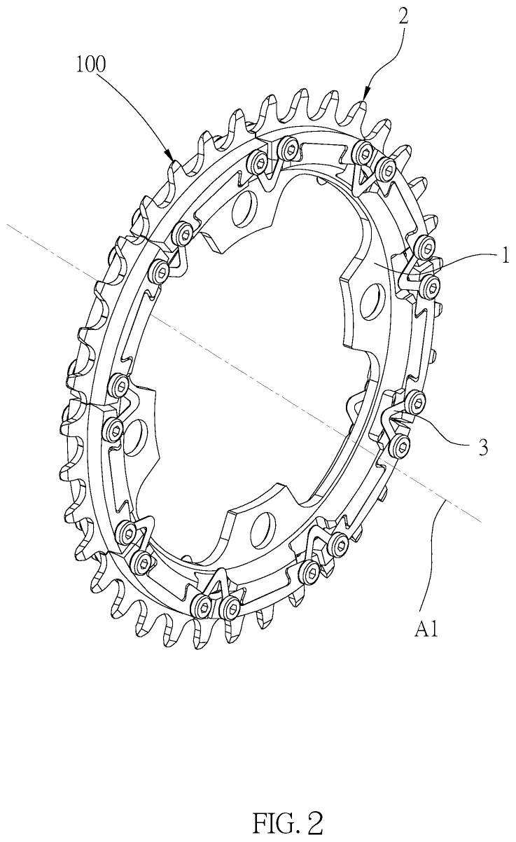

The present disclosure will be described more clearly hereinafter with reference to the accompanying drawings. Referring to FIG. 2 to FIG. 4, a bicycle sprocket 100 according to an embodiment of the present disclosure includes a sprocket body 1, a sprocket ring 2, a plurality of limiting members 3, and a plurality of reinforcing members 4.

As shown in FIG. 2, the sprocket body 1 has a substantially annular shape, and the sprocket ring 2 is attached to the radially outer periphery of the sprocket body 1. The inner side of the sprocket body 1 has a binding portion 16 extending toward a rotation axis A1. The binding portion 16 can be fastened on a spider of a bicycle crank (not shown), or a spider (not shown) of a bicycle and then locked on a crank, so that the sprocket body 1 is coupled with the crank.

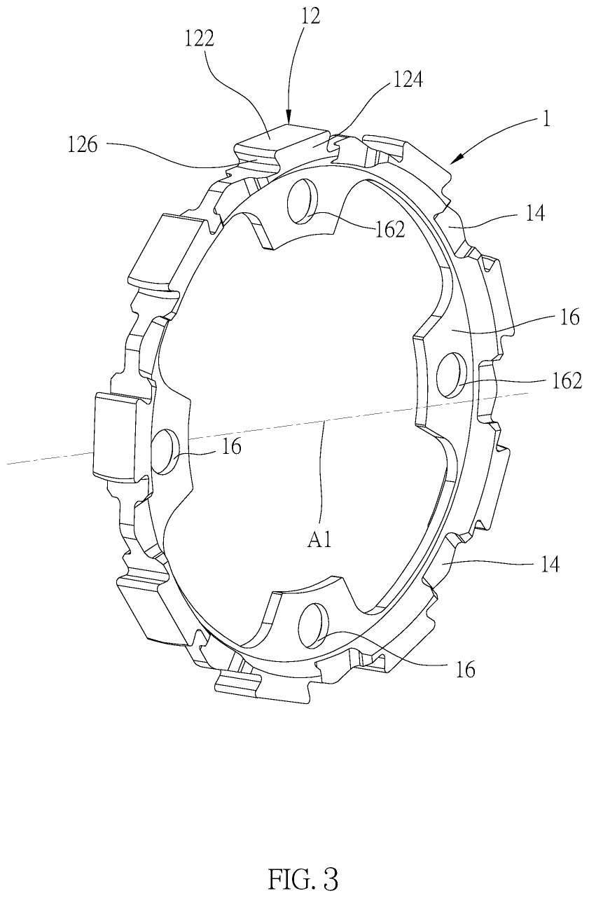

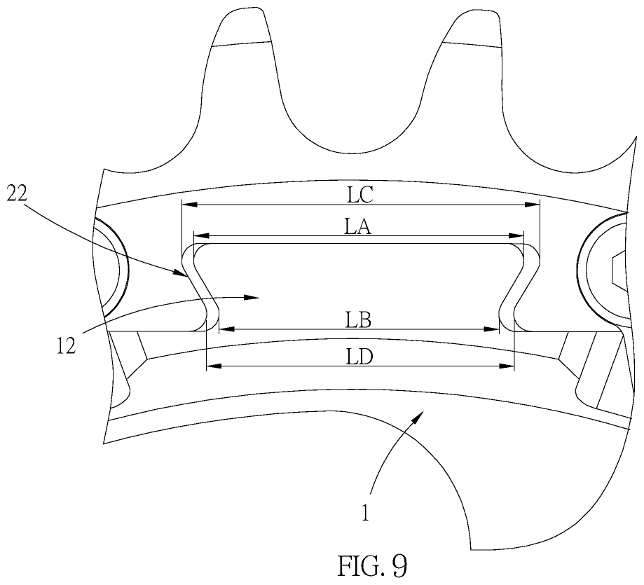

As shown in FIG. 3, the sprocket 100 includes a plurality of first joint portions 12 radially disposed along an outer periphery of the sprocket body 1. In the present embodiment, each of the first joint portions 12 protrudes toward the sprocket ring 2 and each of the first joint portions 12 includes a first joint surface 122, a base portion 124, and two first side walls 126 located at two radial ends of the first joint portion 12. The two first side walls 126 are connected to two radial ends of the first joint surface 122, respectively, and the region therebetween forms a radially outer periphery of the first joint portion 12. The base portion 124 is farer from the sprocket ring 2 than the first joint surface 122. Referring to FIG. 9, the first joint surface 122 of the first joint portion 12 has a first joint surface length LA in the radial direction, which is greater than a base portion length LB of the base portion 124 in the radial direction.

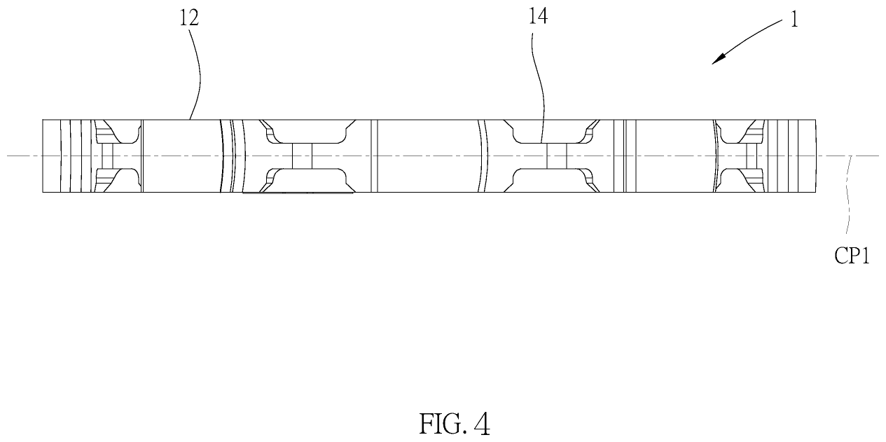

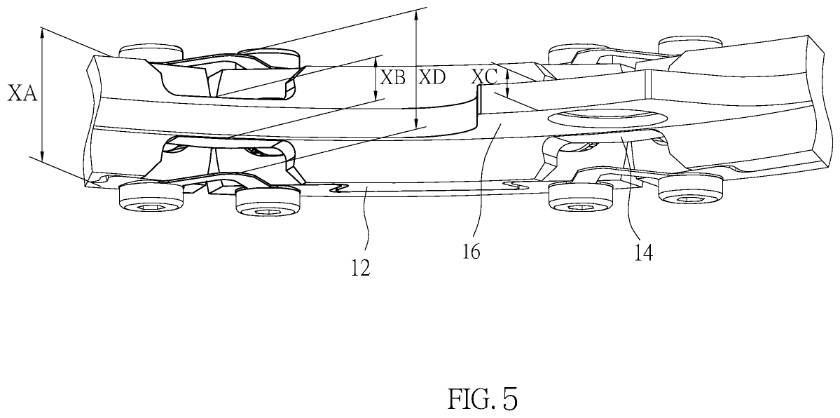

As shown in FIG. 4, the sprocket body 1 further includes a plurality of recesses 14 recessed from an axial surface of the sprocket body 1 toward a central plane CP1, and the recesses 14 and the first joint portions 12 are alternatively disposed on the radially outer periphery of the sprocket body 1. In the present embodiment, the recesses 14 are recessed respectively from two axial surfaces of the sprocket body 1 toward the center plane CP1, and the radial surface of the recess portion 14 may be a convex curved surface protruded toward the sprocket ring 2. In addition, as shown in FIG. 5, in the axial direction which is parallel to the rotation axis A1, the first joint portion 12 has a first joint portion width XA, the recess portion 14 has a recess width XB, the binding portion 16 has a binding portion width XC, and the first joint portion width XA is greater than the recess width XB and the binding portion width XC. In the present embodiment, the first joint portion width XA is greater than the recess width XB, which is greater than the binding portion width XC.

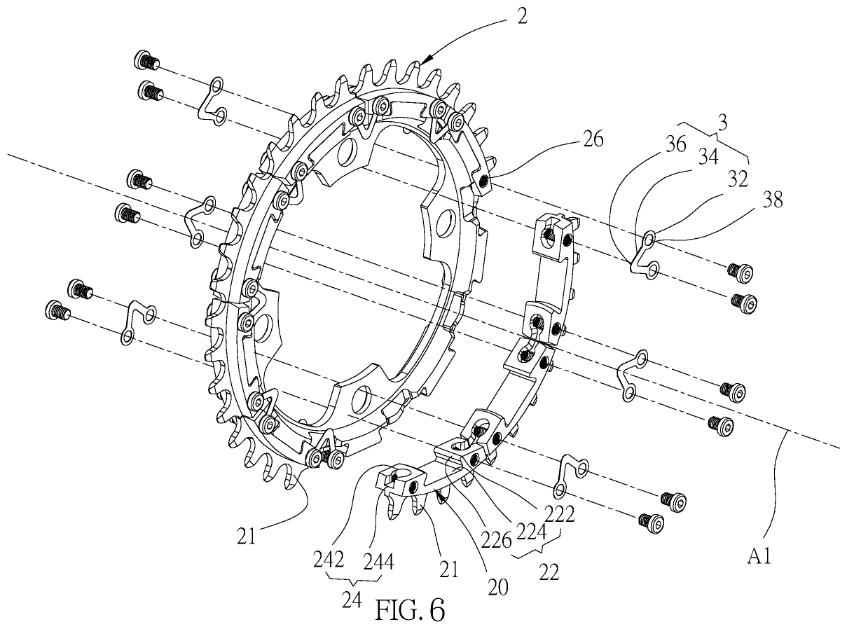

As shown in FIG. 6, the sprocket ring 2 includes a plurality of independent ring pieces 20, which are connected to form the sprocket ring 2. A plurality of sprocket teeth 21 are provided along the radially outer periphery of each ring piece 20 for engaging with the chain of the bicycle. Each ring piece 20 further includes a second joint portion 22 and two third joint portions 24.

The second joint portion 22 is provided on the radially inner circumference of the ring piece 20 and recessed toward the sprocket teeth 21. The configuration of the second joint portion 22 substantially coincides with the first joint portion 12. In this embodiment, the second joint portion 22 can be a sliding groove. The recess of the second joint portion 22 is provided with an opening 222. The second joint portion 22 further includes a second joint surface 224 and two second side walls 226 at the radial ends of the second joint surface 224. The two second side walls 226 are respectively connected to the two radial ends of the second joint surface 224 to form the radially inner circumference of the second joint portion 22. The opening 222 is provided between the two second side walls 226 and farer from the sprocket teeth 21 than the second joint surface 224. Referring to FIG. 9, the second joint surface 224 has a radial second joint surface length LC in the radial direction; the opening 222 has a radial opening length LD, and the second joint surface length LC is greater than the opening length LD.

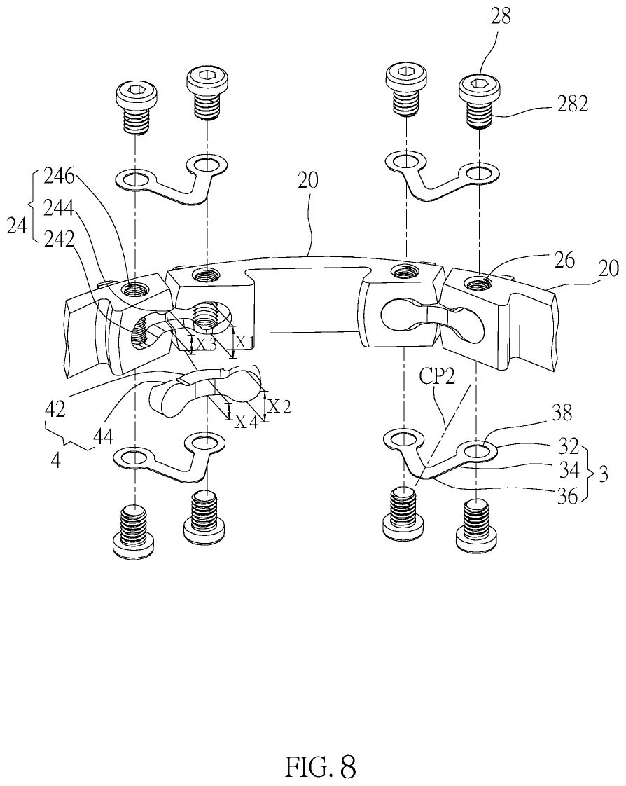

As shown in FIG. 8, two third joint portions 24 are respectively disposed at two radial ends of the ring piece 20. The third joint portion 24 includes a cavity 242 and at least one screw hole 246. The cavity 242 is disposed on a radially inner circumference of the third joint portion 24, and the screw hole 246 is disposed on two axial surfaces of the third joint portion 24. The cavity 242 is recessed toward the second joint portion 22 and provided with a notch 244, which is disposed away from the second joint portion 22. In the present embodiment, the cavity 242 is substantially a notched circular arc. Referring to FIG. 8, the cavity 242 has a cavity width X1 in the axial direction, and the notch 244 has a notch width X3 in the axial direction. In the present embodiment, the cavity width X1 is greater than the notch width X3.

As shown in FIG. 8, the limiting member 3 includes two arm portions 34, a limiting portion 36 and two connecting holes 38. One end of each arm portion 34 is connected to one of the two ends of the limiting portion 36, and the other end of each arm portion 34 is provided with a connecting hole 38. The configuration of the limiting member 3 is symmetrical to an axis of symmetry CP2, and the arm portion 34 is not perpendicular to the axis of symmetry CP2. In the present embodiment, the limiting member 3 has a “V” shape. In other embodiments, the limiting member may also have a “U” shape or a “U” shape and possesses the same structural effect. The limiting member 3 is made of metal. In the present embodiment, the limiting member 3 is made of stainless steel. When being assembled, the two connecting holes 38 of the limiting member 3 are respectively disposed on the two screw holes 246 of the two adjacent third joint portions 24 of the two adjacent ring pieces 20. The connecting hole 38 and the screw hole 246 are further threaded by a fastener 28 to fix the limiting member 3 to the two ring pieces 20. Meanwhile, the limiting portion 36 of the limiting member 3 is disposed at the axially outer side of the recess portion 14 but not in contact with the recess portion 14.

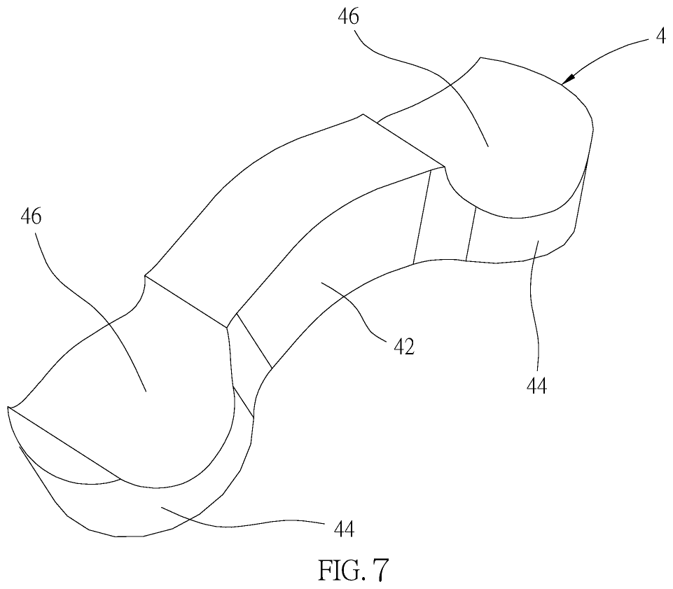

As shown in FIG. 7, each reinforcing member 4 includes a body portion 42 and two extending portions 44 extending from both ends of the body portion 42 in the radial direction. Referring to FIG. 8, in the axial direction, the extending portion 44 has an extending portion width X2, the body portion 42 has a body portion width X4, and the extending portion width X2 is greater than the body portion width X4. When being assembled, the reinforcing member 4 is disposed between the cavities 242 of two adjacent ring pieces 20 and the radial surface of the recess portion 14 of the sprocket body 1. The configuration of the reinforcing member 4 is substantially the same as that of two adjacent cavities 242 of two adjacent third joint portions 24, and matches the two adjacent cavities 242 and the radial surface of the recess portion 14. In the present embodiment, the two extending portions 44 have a curved surface recessed toward the sprocket body 1 to match the rod 282 of the fastener 28; and the body portion 42 also has a curved surface protruding toward the sprocket ring 2 to match the radial surface of the recess portion 14.

In addition, as shown in FIG. 8, in order to mount the reinforcing member 4 between two adjacent third joint portions 24 of two adjacent ring pieces 20, the cavity width X1 of the third joint portion 24 is greater than the extending portion width X2 of the reinforcing member 4; and the notch width X3 of the third joint portion 24 is greater than the body portion width X4 of the reinforcing member 4. In the present embodiment, the extending portion width X2 of the reinforcing member 4 may be greater than the notch width X3 of the third joint portion 24.

Through the above design, the two extending portions 44 of the reinforcing member 4 can be placed into the cavities 242 of two adjacent third joint portions 24. The two extending portions 44 of the reinforcing member 4 are respectively disposed in the cavities 242 of two adjacent third joint portions 24 of two adjacent ring pieces 20, and the body portion 42 can be disposed at the notches 244 of two adjacent third joint portions 24 of two adjacent ring pieces 20. Accordingly, the two extending portions 44 of each reinforcing member 4 can connect the adjacent third joint portions 24 of the adjacent ring pieces 20.

Thereafter, in order to mount the ring pieces 20 on the sprocket body 1, the second joint surface length LC of each ring piece 20 is greater than the first joint surface length LA of the first joint portion 12 of the sprocket body 1. The first joint surface length LA of the first joint portion 12 of the sprocket body 1 is greater than the opening length LD of each ring piece 20. The opening length LD of each ring piece 20 is greater than the base portion length LB of the first joint portion 12 of the sprocket body 1, as shown in FIG. 9.

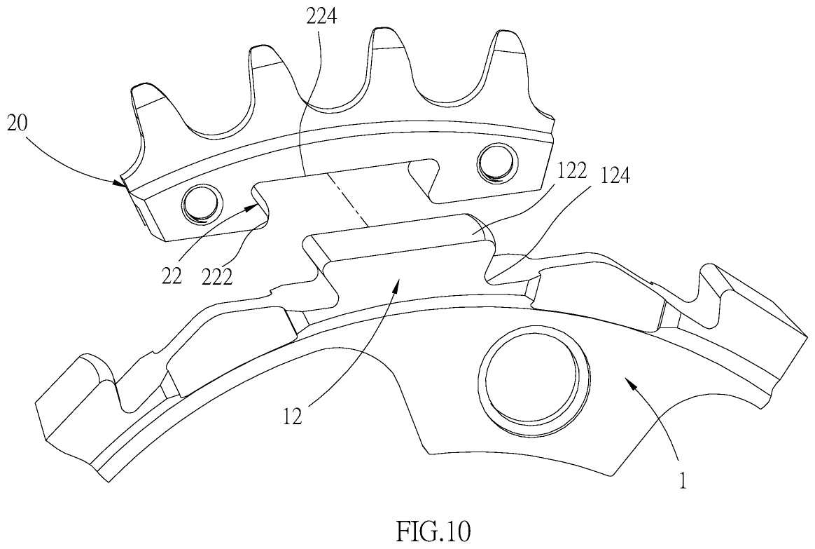

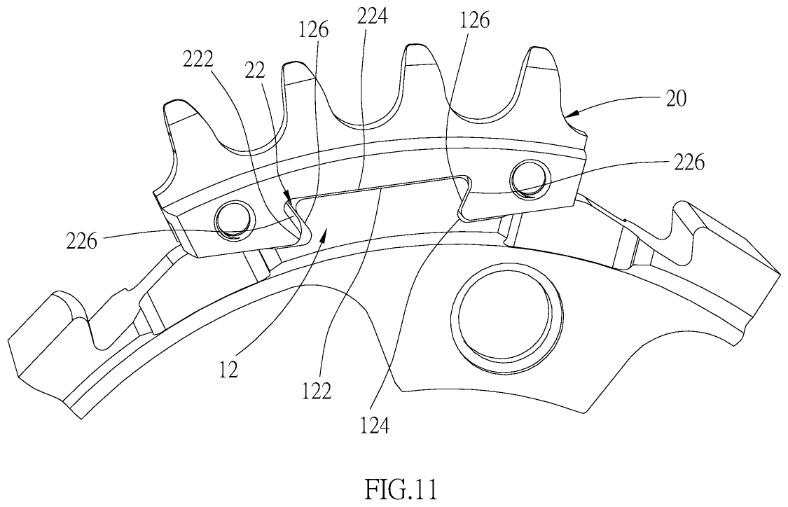

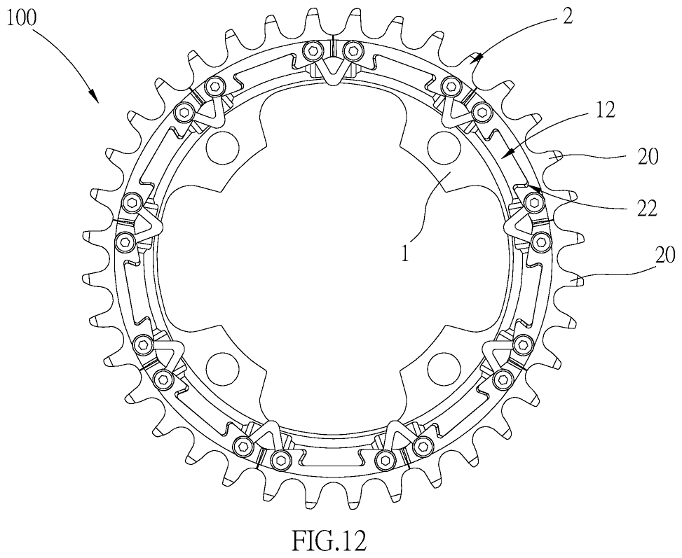

In this way, the second joint portion 22 of each of the ring pieces 20 can be axially mounted to the first joint portion 12 of the sprocket body 1 (referring to FIG. 10). The first joint surface 122 of the first joint portion 12 corresponds to the second joint surface 224 of the second joint portion 22 of each ring pieces 20, and the two first side walls 126 of the first joint portion 12 correspond respectively to the two second side walls 226 of the second joint portion 22 of each ring piece 20 (referring to FIG. 11). Therefore, when each second joint portion 22 of each ring piece 20 has engaged with each first joint portion 12 of the sprocket body 1, all the ring pieces 20 form the sprocket ring 2 around the outer periphery of the sprocket body 1 (referring to FIG. 12). At this time, each reinforcing member 4 is disposed between two adjacent cavities 242 of two adjacent third joint portions 24 of two adjacent ring pieces 20.

Afterwards, as shown in FIG. 8, the two connecting holes 38 of the limiting member 3 are respectively disposed on the two screw holes 246 of two adjacent ring pieces 20, and the screw holes 246 are located on the same axial surface. The two limiting members 3 are respectively disposed on two axial surfaces of the adjacent ring pieces 20. After passing through the connecting hole 38, the fastener 28 is screwed with the corresponding screw hole 246. In the present embodiment, the two extending portions 44 of each reinforcing members 4 have curved surfaces that are recessed toward the sprocket body 1. When the fasteners 28 are screwed, the two extending portions 44 can be kept away from the rod 282 to lock the limiting member 3, thereby connecting the two adjacent ring pieces 20.

At this time, referring to FIG. 5 again, the limiting portions 36 of the limiting members 3 are respectively disposed at the recesses 14 of the sprocket body 1, and the two limiting members 3 located respectively on the two axial surfaces of two adjacent ring pieces 20 have a limiting member width XD therebetween in the axial direction. The limiting member width XD is greater than the recess width XB and the binding portion width XC. In the present embodiment, the limiting member width XD is greater than the first joint portion width XA, which is greater than the recess width XB. The recess width XB is further greater than the binding portion width XC.

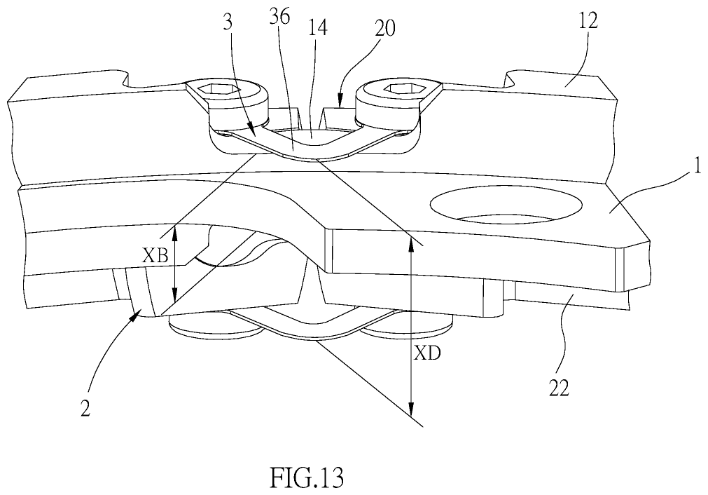

Since the first joint portions 12 of the sprocket body 1 and the second joint portions 22 of the sprocket ring 2 assembled in the above manner are not closely fitted, an predetermined distance the ring piece 20 can be axially moved is thus provided. The greatest predetermined distance is the distance difference between the limiting member width XD and the recess width XB. As shown in FIG. 13, when the ring piece 20 is moved axially relative to the sprocket body 1, the limiting member 3 coupled to the ring piece 20 causes the adjacent ring pieces 20 to move together in the axial direction. When two connected adjacent ring pieces 20 are moved relative to the sprocket body 1 by the maximum predetermined distance, one of the two limiting members 3 arranged on the two axial surfaces of the two adjacent ring pieces 20 will abut against a corresponding recess portion 14 of the sprocket body 1 to limit the scope to which the two connected ring pieces 20 are axially movable relative to the sprocket body 1, so that each of the ring pieces 20 won't detach from the sprocket body 1.

In addition, the second joint portion 22 of each of the ring pieces 20 is axially mounted on the first joint portion 12 of the sprocket body 1, so that the sprocket ring 2 can be axially moved with respect to the sprocket body 1. Also, by the design of the radial length of the second joint surface 224 and the two second side walls 226 of each ring piece 20 in the sprocket body 1 as well as the design of the radial length of the first joint surface 122 and the base portion 124 of the first joint portion 12 of the sprocket body 1, it is possible to prevent the ring pieces 20 of the sprocket ring 2 from being radially detached from the sprocket body 1 while the bicycle sprocket 100 is rotated.

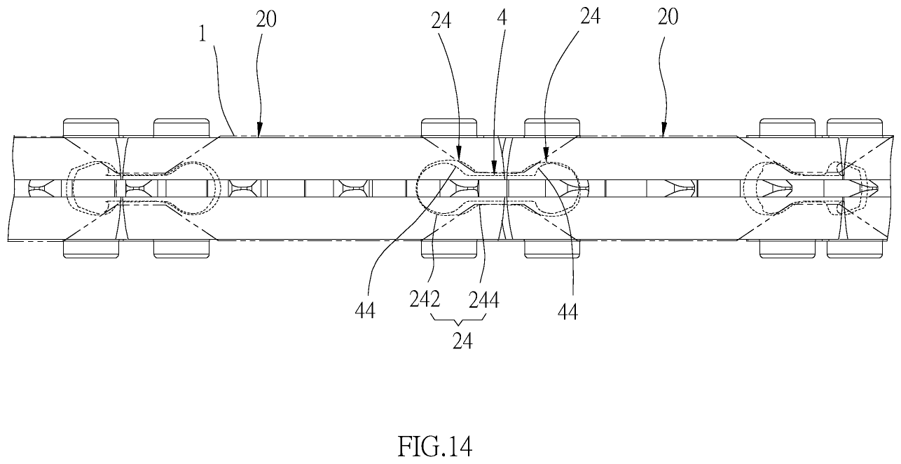

Further, as shown in FIGS. 14 to 15, when the ring piece 20 is axially moved relative to the sprocket body 1, the limiting member 3 connected to the ring piece 20 drives the adjacent ring pieces 20 to axially move together, and the reinforcing member 4 can also drive the adjacent ring piece 20 to move axially. By sandwiching the reinforcing member 4 between the third joint portions 24 of two adjacent ring pieces 20 and the radial surface of the recess portion 14 as well as fitting the configuration of the reinforcing member 4 to that of two adjacent third joint portions 24 and the radial surface of the recess portion 14, each reinforcing member 4 will not be loosened easily in the radial direction, so that the connection between two adjacent ring pieces 20 is more stable, thereby preventing the second joint portion 22 of the ring piece 20 from axially sliding off the first joint portion 12 of the sprocket body 1.

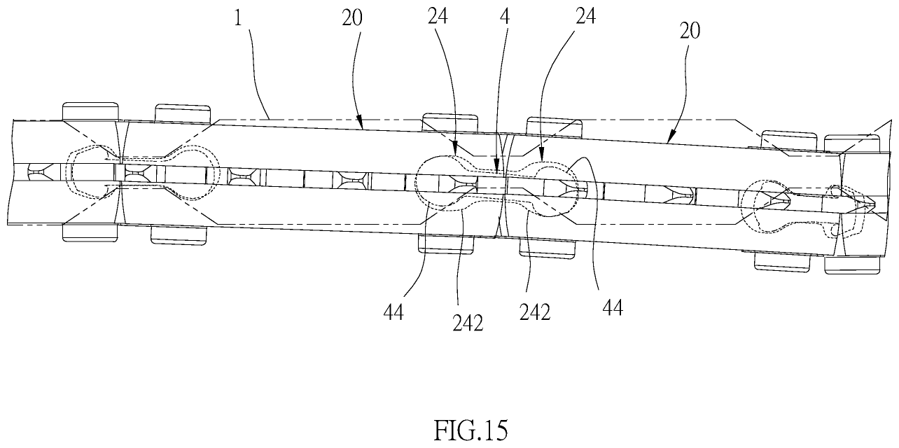

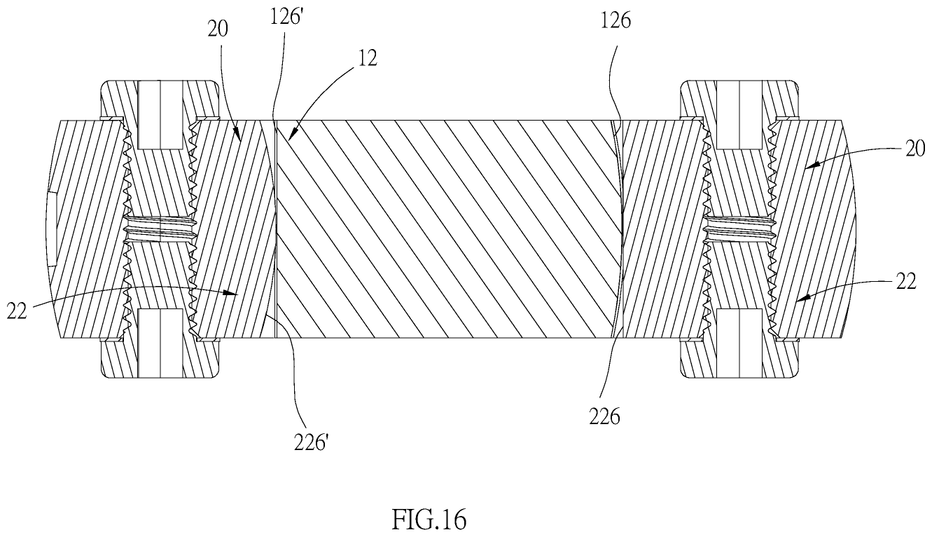

In addition, as shown in FIG. 16, when the second joint portion 22 of each ring piece 20 is mounted on the first joint portion 12 of the sprocket body 1, the second side walls 226, 226′ of the second joint portion 22 face the respective first side walls 126, 126′ of the corresponding first joint portion 12. In this embodiment, the first side wall 126 of the first joint portion 12 has a convex curved surface protruding toward the second side wall 226, and the second side wall 226 corresponding thereto is planar. The first side wall 126′ of the first joint portion 12 is planar, and the second side wall 226′ corresponding thereto is a curved surface protruding toward the first side wall 126′. In this way, by the above design, the interference of each ring piece 20 being moved relative to the sprocket body 1 can be effectively reduced, and the ring piece 20 can be axially yawed relative to the sprocket body 1, thereby making the ring piece 20 move in the axial direction more smoothly.

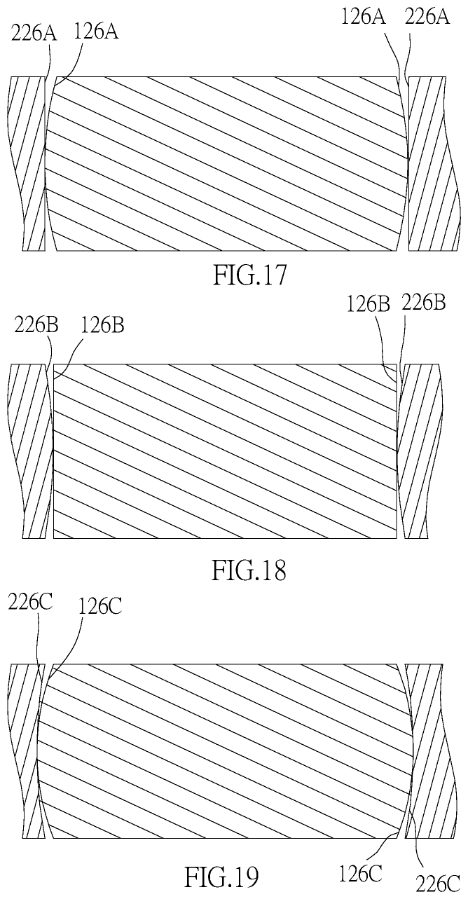

In addition to the above structure, each of the first side walls 126 and each of the second side walls 226 can also be implemented in the following manner. In the second embodiment, each of the first side walls 126A is convexly curved toward the second side walls 226A, and each of the second side wall 226A is planar (referring to FIG. 17). In the third embodiment, each of the first side walls 126B is planar, and each of the second side walls 226B is convexly curved toward the first side walls 126B (referring to FIG. 18) In the fourth embodiment, each of the first side walls 126C has a convexly curved surface that protrudes toward the second side wall 226C, and each of the second side walls 226C has a concavely curved surface that is recessed away from the first side wall 226C (referring to FIG. 19). The second to fourth embodiments described above can also achieve the aforementioned effects.

In this way, when the rider drives the bicycle and changes the gear position, the chain engaged with the bicycle sprocket 100 is driven by the rear freewheel to generate lateral stresses, thereby pulling the bicycle sprocket 100 to shift. Meanwhile, the two adjacent ring pieces 20 can assist in the axial displacement of the bicycle sprocket 100 relative to the sprocket body 1.

Furthermore, by the manners that each of the limiting members 3 limits the scope to which the respective ring pieces 20 are movable relative to the sprocket body 1 and that each reinforcing member 4 is disposed between the two adjacent ring pieces 20, the connection between two adjacent ring pieces 20 will be more stable, and the adjacent ring pieces 20 will not be disengaged from the sprocket body 1 when being moved axially relative to the sprocket body 1, so that the sprocket ring 2 composed of the ring pieces 20 can be operated more smoothly on the sprocket body 1. Also, the axial offset generated correspondingly by the lateral stress of the chain can reduce the friction between the sprocket teeth 21 of the sprocket ring 2 and the chain as well as the wear of the sprocket teeth 21, thereby solving the problem that the chainring teeth 51 of the conventional bicycle chainring 500 rubs against the chain 52, generates noise and thus increases the wear of the chainring teeth 51 of the conventional bicycle chainring 500.

It must be pointed out that the embodiments described above are only some embodiments of the present disclosure. All equivalent structures which employ the concepts disclosed in this specification and the appended claims should fall within the scope of the present disclosure.

What is claimed is:

1. A bicycle sprocket comprising:
a sprocket body comprising a plurality of first joint portions, each of which is disposed on a radially outer periphery of the sprocket body;
a sprocket ring comprising a plurality of ring pieces, each of which includes a plurality of sprocket teeth and a second joint portion, wherein each of the sprocket teeth is disposed on a radially outer periphery of the ring piece, and the second joint portion is disposed on a radially inner circumference of the ring piece; and
a plurality of limiting members;
wherein each of the first joint portions of the sprocket body cooperates with the second joint portion of each of the ring piece, and each of the limiting members is disposed on an axial surface of two adjacent ring pieces.

2. The bicycle sprocket according to claim 1, wherein each of the first joint portions protrudes toward the sprocket ring, each of the second joint portions recesses away from the sprocket body, and each of the protruded first joint portion and each of the recessed second joint portion are substantially matched with each other in configuration.

3. The bicycle sprocket according to claim 2, wherein each of the first joint portions includes a first joint surface, two first side walls, and a base portion, the two first side walls are respectively connected to the radial ends of the first joint surface, and the base portion is disposed on the first joint portion and farer from the sprocket ring than the first joint surface.

4. The bicycle sprocket according to claim 3, wherein each of the second joint portions includes a second joint surface, two second side walls, and an opening, the two second side walls are respectively connected to the radial ends of the second joint surface, and the opening is provided between the two second side walls and farer from the sprocket teeth than the second joint surface.

5. The bicycle sprocket according to claim 4, wherein one of a pair of the first side wall and the second side wall is convexly curved, and the other is planar.

6. The bicycle sprocket according to claim 4, wherein the first side wall is concavely curved away from the second side wall, and the second side wall is convexly curved toward the first side wall.

7. The bicycle sprocket according to claim 4, wherein the second joint surface of each of the second joint portions has a second joint surface length in the radial direction, the second joint surface length is greater than a first joint surface length of the first joint surface of each of the first joint portions in the radial direction, the first joint surface length is greater than an opening length of the opening of each of the second joint portions in the radial direction, and the opening length is greater than a base portion length of the base portion of each of the first joint portions in the radial direction.

8. The bicycle sprocket according to claim 1, wherein the sprocket body includes a plurality of recess portions, each of the recess portion is formed on an axial surface of the sprocket body, and the recess portion and the first joint portion are alternately disposed on a radially outer periphery of the sprocket body.

9. The bicycle sprocket according to claim 8, wherein a limiting member width between two limiting members in the axial direction is greater than a first joint portion width of the first joint portion in the axial direction, and the first joint portion width is greater than a recess width of the recess portion in the axial direction.

10. The bicycle sprocket according to claim 1, wherein the limiting member is made of a metal.

11. The bicycle sprocket according to claim 8, wherein each of the limiting members comprises two arm portions, a limiting portion and two connecting holes, the two arm portions are respectively formed at two ends of the limiting portion, and the connecting hole is formed at one end of the arm portion away from the limiting portion.

12. The bicycle sprocket according to claim 11, wherein the limiting member is centered on the limiting portion and symmetrical about an axis of symmetry, and the arm portion is not perpendicular to the axis of symmetry.

13. The bicycle sprocket according to claim 11, wherein the two arm portions of the limiting member are respectively disposed on two adjacent ring pieces, and the limiting portion of the limiting member is provided at an axially outer side of the recess.

14. The bicycle sprocket according to claim 13, wherein the two ends of the ring piece are respectively provided with a third joint portion, the third joint portion includes a cavity provided on an inner circumference of the ring piece and a screw hole through two axial surfaces of the ring piece, and the cavity is recessed toward the sprocket teeth.

15. The bicycle sprocket according to claim 14, wherein the two connecting holes of the limiting member are respectively disposed on two screw holes of two adjacent ring pieces, and the connecting hole and the screw hole are respectively threaded by a fastener to fix the limiting member to the axial surface of the two adjacent ring pieces, so that the two arm portions of the limiting member are respectively connected to the two adjacent ring pieces.

16. The bicycle sprocket according to claim 14, further comprising a plurality of reinforcing members disposed between the cavities of two adjacent ring pieces and an outer periphery of the recess of the sprocket body, wherein the configuration of the reinforcing member substantially matches the cavity and the outer periphery of the recess.

17. The bicycle sprocket according to claim 16, wherein the cavity of each of the third joint portions is provided with a notch, the notch is disposed away from the second joint portion, each of the reinforcing members comprises a body portion and two extending portions extending from two ends of the body portion, the two extending portions of each of the reinforcing members are respectively disposed in the cavities of two adjacent ring pieces, and the body portion of each of the reinforcing member is disposed at the notches of two adjacent ring pieces.

18. The bicycle sprocket according to claim 17, wherein in the axial direction, the cavity has a cavity width, which is greater than an extending portion width of the reinforcing member, the extending portion width is greater than a notch width of the notch, and the notch width is greater than a body portion width of the body portion.
